(19) United States
(12) Patent Application Publication
(10) Pub. No.: US 2026/0118186 A1
(43) Pub. Date: Apr. 30, 2026

(54) A METHOD FOR DETERMINING TEMPERATURE INFORMATION, OR INFORMATION RELATED TO TEMPERATURE INFORMATION, RELATED TO A STATIC ELECTRIC INDUCTION DEVICE ASSEMBLY

(71) Applicant: Hitachi Energy Ltd, Zürich (CH)

(72) Inventor: Tor LANERYD, Enköping (SE)

(21) Appl. No.: 19/167,166

(22) PCT Filed: Mar. 15, 2024
(86) PCT No.: PCT/EP2024/057010

§ 371 Date: Sep. 19, 2025

(30) Foreign Application Priority Data
Mar. 20, 2023 (EP) 23162849.6

(51) Int. Cl. G01K 11/32

(52) U.S. Cl. CPC G01K 11/32

(57) ABSTRACT

The present invention relates to a method for determining temperature information, or information related to temperature information, related to a static electric induction device assembly. The static electric induction device assembly having a vertical extension in a vertical direction. The method includes performing the following for at least a static electric induction device portion: determining a heat loss value, indicative of a heat loss for the static electric induction device portion, the static electric induction device portion having a vertical static electric induction device portion position in the vertical direction; determining a liquid temperature value, indicative of a temperature of a liquid in the vertical static electric induction device portion position, and determining a temperature, or information related to temperature information, of the static electric induction device portion using the liquid pressure difference, the heat loss value and the liquid temperature value.

### CROSS REFERENCE TO RELATED APPLICATIONS

This application is a 35 U.S.C. § 371 national stage application of International Application No. PCT/EP2024/057010 filed on Mar. 15, 2024, which in turn claims foreign priority to European Patent Application No. 23162849.6 filed on Mar. 20, 2023, the disclosures and content of which are incorporated by reference herein in their entirety.

### TECHNICAL FIELD

The present disclosure relates to a method for determining temperature information, or information related to temperature information, related to a static electric induction device assembly. Moreover, the present disclosure relates to each one of a computer program product, a non-transitory computer-readable storage medium and a control unit.

### BACKGROUND

In a static electric induction device assembly, such as an assembly comprising a transformer and/or a shunt reactor, there is generally a desire to determine the temperature of at least a portion of a static electric induction device forming part of such an assembly.

Purely by way of example, it may be desired to determine a so-called hotspot temperature of the static electric induction device. A hotspot generally relates to the hottest portion, or at least one of the hottest portions, of the static electric induction device. Information pertaining to the hotspot temperature may for instance be relevant when assessing an insulation ageing of a static electric induction device.

However, it may be challenging to measure a temperature in a desired portion of the static electric induction device. For instance, should a temperature sensor, such as a thermometer or the like, be placed at or by the hotspot, there is a risk that the presence of such a temperature sensor may impair the cooling of the hotspot, for instance by impairing the flow of a coolant around the hotspot.

### SUMMARY

In view of the above, an object of a first aspect of the present disclosure is to determine temperature information related to a static electric induction device assembly in a straightforward manner. The above object is achieved by a method according to claim 1.

As such, the first object of the present disclosure relates to a method for determining temperature information, or information related to temperature information, related to a static electric induction device assembly. The static electric induction device assembly has a vertical extension in a vertical direction.

The static electric induction device assembly comprises an enclosure, a static electric induction device and a liquid, whereby the enclosure accommodates the static electric induction device and the liquid such that the static electric induction device is at least partially, preferably fully, submerged into the liquid. The static electric induction device comprises a static electric induction device portion that is submerged into the liquid. The static electric induction device assembly further comprises an enclosing member.

The static electric induction device is at least partially enclosed by the enclosing member, wherein at least one cooling duct is formed between the static electric induction device and the enclosing member and/or wherein the at least one cooling duct extends at least partially through the static electric induction device. The at least one cooling duct is at least partially delimited by the static electric induction device portion. The at least one cooling duct comprises a lower inlet and an upper outlet, as seen in the vertical direction, wherein each one of the lower inlet and the upper outlet is in fluid communication with the liquid. The at least one cooling duct is adapted to convey the liquid from the lower inlet to the upper outlet.

The method comprises determining a liquid pressure difference between a liquid pressure at the upper outlet and a liquid pressure at the lower inlet. The method comprises performing the following for at least the static electric induction device portion:
determining a heat loss value, indicative of a heat loss for the static electric induction device portion, the static electric induction device portion having a vertical static electric induction device portion position in the vertical direction;
determining a liquid temperature value, indicative of a temperature of the liquid in the vertical static electric induction device portion position, and
determining a temperature, or information related to temperature information, of the static electric induction device portion using the liquid pressure difference, the heat loss value and the liquid temperature value.

The above implies that the temperature of the static electric induction device portion may be determined in a straightforward manner. For instance, the above recited method implies that the temperature of the static electric induction device portion may be determined without necessarily employing a temperature sensor that is located at or by the static electric induction device portion.

Optionally, the method comprises determining a temperature profile indicative of a temperature of the liquid inside the enclosure but outside the enclosing member at a plurality of different vertical positions between an upper outlet vertical position of the upper outlet and a lower inlet vertical position of the lower inlet.

The temperature profile indicated above may be useful when determining e.g. the temperature, or information related to temperature information, of the static electric induction device portion. Moreover, since the temperature profile is indicative of the temperature outside the enclosing member, the temperature profile may be determined with a low risk for negatively affecting e.g. the flow of liquid around the static electric induction device portion.

Optionally, the step of determining the liquid temperature value comprises using the temperature profile and the vertical static electric induction device portion position in the vertical direction of the static electric induction device portion.

The above implies that the liquid temperature value may be determined in a straightforward manner.

Optionally, the feature of determining the temperature profile comprises using a plurality of temperature sensors arranged inside the enclosure but outside the enclosing member between the upper outlet vertical position and the lower inlet vertical position.

Using a plurality of temperature sensors arranged outside the enclosing member implies an appropriately low risk that the temperature sensor may impair the liquid flow around the static electric induction device portion.

Optionally, the feature of determining the temperature profile comprises the following:
determining measured temperature data using a measurement assembly, the measured temperature data comprising a temperature in each one of a plurality of different locations of the static electric induction device assembly as a function of time for a reference time range when the static electric induction device assembly is in a condition in which at least a portion of the static electric induction device generates heat during at least a portion of the reference time range,
generating a temperature model for estimated temperature data, the estimated temperature data corresponding to an estimated temperature in each one of the plurality of different locations of the static electric induction device assembly as a function of time, the temperature model comprising a learning model representing the estimated temperature data as well as the measured temperature data, and
training the learning model using the measured temperature data to thereby obtain the temperature model, and
determining the temperature profile using the temperature model.

The above implies a versatile implementation for determining the temperature profile.

Optionally, the learning model comprises a neural network, preferably a multilayer neural network.

Optionally, the measurement assembly comprises a fibre optic sensor that is located within the enclosing member. Preferably, the static electric induction device comprises a winding and the fibre optic sensor is at least partially located in the winding.

The use of a fibre optic sensor implies an accurate determination of the measured temperature data.

Optionally, the step of determining the liquid pressure difference between the liquid pressure at the upper outlet and the liquid pressure at the lower inlet comprises using the temperature profile and information relating to a density of the liquid as a function of temperature.

Using the temperature profile for determining the liquid pressure difference implies that the liquid pressure difference may be determined without necessarily requiring the use of e.g. pressure sensors. Moreover, using the temperature profile implies that appropriately accurate values of the liquid pressure difference may be obtained.

Optionally, the method comprises determining a fluid flow rate of the liquid flowing in the at least one cooling duct on the basis of the liquid pressure difference and a factor indicative of the flow resistance of the duct.

The above implementation for determining the fluid flow rate may provide appropriately accurate results.

Optionally, the step of determining the heat loss value comprises determining a value indicative of an electric power fed to the static electric induction device portion.

The heat loss value may be proportional to the electric power fed to the static electric induction device portion. As such, determining a value indicative of an electric power fed to the static electric induction device portion for determining the heat loss value implies that the heat loss value may be determined with an appropriate accuracy.

Optionally, the step of determining the temperature of the static electric induction device portion using the liquid pressure difference, the heat loss value and the liquid temperature value comprises determining a heat transfer coefficient between the static electric induction device portion and the liquid. The heat transfer coefficient is a function of the fluid flow rate, wherein the temperature of the static electric induction device portion is determined as the sum of the liquid temperature value and a parameter proportional to the ratio between the heat loss value and the heat transfer coefficient.

Optionally, the static electric induction device comprises a winding, wherein the static electric induction device portion is a portion of the winding.

Optionally, the winding comprises a plurality of discs, the method comprising performing the method according to any one of the preceding claims for each one of a set of discs of the plurality of discs.

Optionally, the static electric induction device portion is associated with an area of the static electric induction device with a relatively high temperature in comparison to its surroundings.

Optionally, the liquid comprises, preferably is constituted by, a dielectric liquid. Optionally, the static electric induction device comprises a transformer and/or a shunt reactor.

A second aspect of the present disclosure relates to a computer program product comprising program code for performing, when executed by a processor device, the method of the first aspect of the present disclosure.

A third aspect of the present disclosure relates to a non-transitory computer-readable storage medium comprising instructions, which when executed by a processor device, cause the processor device to perform the method of the first aspect of the present disclosure.

A fourth aspect of the present disclosure relates to a control unit arranged to perform the method of the first aspect of the present disclosure.

### BRIEF DESCRIPTION OF THE DRAWINGS

With reference to the appended drawings, below follows a more detailed description of embodiments of the disclosure cited as examples.

In the drawings:

FIG. 1 is a schematic illustration of a static electric induction device assembly;

FIG. 2 is a schematic illustration of a static electric induction device and graphs of a heat loss value and a temperature of a liquid, each one as a function of a vertical position along the static electric induction device, and

FIG. 3 is a schematic illustration of a portion of an implementation of a static electric induction device.

### DETAILED DESCRIPTION OF PREFERRED EMBODIMENTS

Preferred embodiments of the present disclosure will be discussed hereinbelow with reference to the appended drawings.

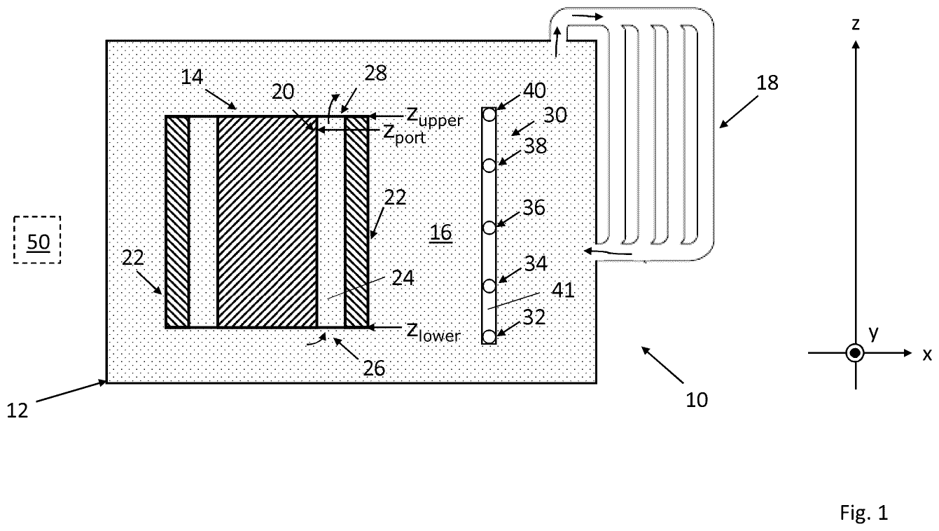

FIG. 1 schematically illustrates an implementation of a static electric induction device assembly 10. The static electric induction device assembly 10 has a vertical extension in a vertical direction z. Moreover, as indicated in FIG. 1, the static electric induction device assembly 10 may also have an extension in a longitudinal direction x and a transversal direction y. The longitudinal direction x and the transversal direction y may form a horizontal plane.

As indicated in FIG. 1, the static electric induction device assembly 10 comprises an enclosure 12, a static electric induction device 14 and a liquid 16. Purely by way of example, the enclosure 12 may be referred to as a tank. Moreover, again purely be way of example, the enclosure 12 may comprise a radiator 18. The radiator 18 may be in fluid communication with the interior of the enclosure 12 such that liquid 16 may be conveyed through the radiator 18 whereby the thus conveyed liquid may be cooled and returned to the interior of the enclosure 12. The above capability is indicated by arrows in FIG. 1.

Moreover, as indicated in FIG. 1, the enclosure 12 accommodates the static electric induction device 14 and the liquid 16 such that the static electric induction device 14 is at least partially, preferably fully, submerged into the liquid 16. Moreover, as indicated in FIG. 1 the static electric induction device 14 comprises a static electric induction device portion which is submerged into the liquid 16. Generally, and as indicated in FIG. 1, the static electric induction device portion 20 is fully submerged into the liquid 16. Moreover, as indicated in FIG. 1, the static electric induction device portion 20 has a vertical static electric induction device portion position zₚₒᵣₜ in the vertical direction z.

The static electric induction device assembly 10 further comprises an enclosing member 22. At least one cooling duct 24 is formed between the static electric induction device 14 and the enclosing member 22 and/or the at least one cooling duct 24 extends at least partially through the static electric induction device 14. The at least one cooling duct 24 is at least partially delimited by the static electric induction device portion 20.

In the FIG. 1 implementation of the static electric induction device assembly 10, the at least one cooling duct 24 is formed between the static electric induction device 14 and the enclosing member 22. However, it is also envisaged that in other implementations of the static electric induction device assembly 10, the at least one cooling duct 24 may extend through one or more other portions of the static electric induction device assembly 10. As a non-limiting example, the at least one cooling duct 24 may extend at least partially through the static electric induction device 14, such as at least partially through a core (not shown) of the static electric induction device 14.

The at least one cooling duct 24 comprises a lower inlet 26 and an upper outlet 28, as seen in the vertical direction z, wherein each one of the lower inlet 26 and the upper outlet 28 is in fluid communication with the liquid 16. The at least one cooling duct 24 is adapted to convey the liquid 16 from the lower inlet 26 to the upper outlet 28.

Moreover, though purely by way of example, the FIG. 1 implementation of the static electric induction device assembly 10 comprises a temperature sensor assembly 30, details of which will be discussed further hereinbelow. However, it is also envisaged that other implementations of the static electric induction device assembly 10 need not necessarily comprise a temperature sensor assembly 30.

As a non-limiting example, the liquid 16 may comprise, preferably be constituted by, a dielectric liquid, such as a mineral oil.

Moreover, though purely by way of example, the static electric induction device 14 may comprise, or even be constituted by, a transformer or a shunt reactor.

The first object of the present disclosure relates to a method for determining temperature information, or information related to temperature information, related to a static electric induction device assembly 10. In particular, the first object of the present disclosure relates to a method for determining the temperature Tₚₒᵣₜ, or information related to temperature information, of the static electric induction device portion 20.

Purely by way of example, the static electric induction device portion 20 may be associated with an area of the static electric induction device 14 with a relatively high temperature in comparison to its surroundings. As a non-limiting example, the static electric induction device portion 20 may be a so called hotspot of the static electric induction device 14.

The method comprises determining a liquid pressure difference Δp between a liquid pressure at the upper outlet 28 and a liquid pressure at the lower inlet 26. Purely by way of example, such a liquid pressure difference Δp may be determined using pressure sensors (not shown in FIG. 1). Alternatively, as will be discussed further hereinbelow, the liquid pressure difference Δp may be determined using information indicative of the temperature of the liquid 16.

The method according to the first aspect of the present disclosure comprises performing the following for at least the static electric induction device portion 20:
determining a heat loss value Q, indicative of a heat loss for the static electric induction device portion 20, the static electric induction device portion 20 having a vertical static electric induction device portion position zₚₒᵣₜ in the vertical direction z,
determining a liquid temperature value T_{liq}(zₚₒᵣₜ), indicative of a temperature of the liquid 16 in the vertical static electric induction device portion position zₚₒᵣₜ,
determining a temperature Tₚₒᵣₜ, or information related to temperature information, of the static electric induction device portion 20 using the liquid pressure difference Δp, the heat loss value Q and the liquid temperature value T_{liq}(zₚₒᵣₜ).

The liquid temperature value T_{liq}(zₚₒᵣₜ), indicative of a temperature of the liquid 16 in the vertical static electric induction device portion position zₚₒᵣₜ, may be determined in a plurality of different ways. As a non-limiting example, the liquid temperature value T_{liq}(zₚₒᵣₜ) may be determined using a single temperature sensor, such as thermometer, adapted to measure the temperature of the liquid 16 in the vertical static electric induction device portion position zₚₒᵣₜ.

However, purely by way of example, the method may comprise determining a temperature profile indicative of a temperature of the liquid 16 inside the enclosure 12 but outside the enclosing member 22 at a plurality of different vertical positions between an upper outlet vertical position zᵤₚₚₑᵣ of the upper outlet 28 and a lower inlet vertical position z_{lower} of the lower inlet 26. Purely by way of example, the temperature profile may be indicative of a temperature of the liquid 16 inside the enclosure 12 but at least 10 mm, as seen in a horizontal direction in the horizontal plane formed by the longitudinal direction x and the transversal direction y, outside the enclosing member 22.

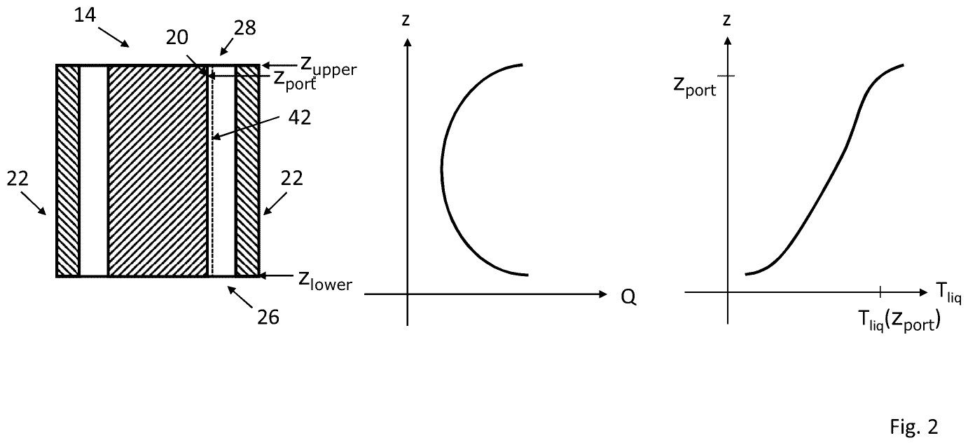

To this end, reference is made to FIG. 2 illustrating the temperature T_{liq} of the liquid 16 in the enclosure 12 as a function of the vertical position z. Since colder liquid has a higher density than hotter liquid, the temperature profile is indicative of a temperature T_{liq} that increases with an increasing vertical position z.

The temperature profile exemplified in FIG. 2 may be used for a plurality of purposes. As a non-limiting example, the step of determining the liquid temperature value T_{liq}(zₚₒᵣₜ) may comprise using the temperature profile and the vertical static electric induction device portion position zₚₒᵣₜ in the vertical direction z of the static electric induction device portion 20. The above example is indicated in FIG. 2, indicating the liquid temperature value T_{liq}(zₚₒᵣₜ). Purely by way of example, the liquid temperature value T_{liq}(zₚₒᵣₜ) may be determined by interpolating values of the temperature profile for different vertical positions in order to obtain the liquid temperature value T_{liq}(zₚₒᵣₜ) at the vertical static electric induction device portion position zₚₒᵣₜ.

The temperature profile may be determined in a plurality of different ways. As a non-limiting example, the feature of determining the temperature profile may comprise using a plurality of temperature sensors arranged inside the enclosure 12 but outside the enclosing member 22 between the upper outlet vertical position zᵤₚₚₑᵣ and the lower inlet vertical position z_{lower}.

To this end, reference is made to FIG. 1 again illustrating an implementation of the static electric induction device assembly 10 comprising a temperature sensor assembly 30. The FIG. 1 temperature sensor assembly 30 comprises a plurality of temperature sensors 32, 34, 36, 38, 40 located at different vertical positions between the outlet vertical position zᵤₚₚₑᵣ and the lower inlet vertical position z_{lower}. As non-limiting examples, each one of the temperature sensors 32, 34, 36, 38, 40 could be any one of the following type of sensors: thermocouples, thermistors, resistance thermometers and fiber optic temperature sensors.

As a non-limiting example, the temperature sensor assembly 30 may comprise an elongate member 41, such as a stick, to which each one of the temperature sensors 32, 34, 36, 38, 40 is attached. Purely by way of example, the elongate member 41 may be made of an insulating material.

Purely by way of example, the temperature sensor assembly 30 may be located outside the enclosing member 22 such that a minimum distance, as seen in a horizontal direction in the horizontal plane formed by the longitudinal direction x and the transversal direction y, between the enclosing member 22 and the temperature sensor assembly 30 is at least 10 mm. The distance of at least 10 mm can be used for any embodiment of the present disclosure.

However, it should be noted that the temperature profile need not be determined using temperature sensors 32, 34, 36, 38, 40 as indicated above.

To this end, though purely by way of example, the feature of determining the temperature profile may comprise the following:
determining measured temperature data using a measurement assembly (42, see FIG. 2), the measured temperature data comprising a temperature in each one of a plurality of different locations of the static electric induction device assembly as a function of time for a reference time range when the static electric induction device assembly is in a condition in which at least a portion of the static electric induction device generates heat during at least a portion of the reference time range,
generating a temperature model for estimated temperature data, the estimated temperature data corresponding to an estimated temperature in each one of the plurality of different locations of the static electric induction device assembly as a function of time, the temperature model comprising a learning model representing the estimated temperature data as well as the measured temperature data, and
training the learning model using the measured temperature data to thereby obtain the temperature model,
determining the temperature profile using the temperature model.

As a non-limiting example, the learning model may comprise a neural network (not shown), preferably a multilayer neural network.

Purely by way of example, the feature of determining the temperature profile using a learning model that comprises a neural network may use the learning model for solving a partial differential equation such as the partial differential equation presented below:

$$\frac{\partial T}{\partial t} - D ( T ) {∇}^{2} T = q ( I ( t ) , T ) - T \qquad Eq . 1$$

wherein:
T=T(x, t) represents a temperature in each one of a plurality of different locations (x) of the liquid 16 as function of time (t);
D(T) represents a temperature dependent material property, such as heat conductivity, of at least a portion of the enclosure 12, and
q(I(t),T) represents heat generated by the static electric induction device 14.

It should be noted that the above partial differential equation according to Eq. 1 merely serves as an example of a partial differential equation that can be used for determining the temperature model for estimated temperature data. In other implementations of determining the temperature profile, the partial differential equation may include more terms such as for instance additional source terms. As non-limiting examples, an additional source term may relate to heat losses through a wall of the enclosure 12 and/or stray losses in metallic parts of the static electric induction device 14.

With reference to FIG. 2, the measurement assembly 42 may comprise a fibre optic sensor that is located within the enclosing member 22. Preferably, the static electric induction device comprises a winding (not shown in FIG. 2) and the fibre optic sensor is at least partially located in the winding. Alternatively, as a non-limiting example, the measurement assembly 42 may comprise a temperature sensor (not shown) for measuring a temperature of the liquid 16 in one or more locations within the enclosure 12, such as an uppermost position of the enclosure 12. As another non-limiting alternative, the measurement assembly 42 may comprise a temperature sensor adapted to measure the temperature ambient of the enclosure 12. Moreover, purely by way of example, the measurement assembly 42 may comprise a thermal camera (not shown) adapted to capture thermal images of an outer side of the enclosure 12 or thermocouples attached to the outer side of the enclosure 12. Purely by way of example, the measurement assembly 42 may comprise one or more of the examples presented above.

Irrespectively of how the temperature profile has been determined, the step of determining the liquid pressure difference Δp between the liquid pressure at the upper outlet 28 and the liquid pressure at the lower inlet 26 may comprise using the temperature profile and information relating to a density of the liquid as a function of temperature.

Purely by way of example, the liquid pressure difference Δp may be determined in accordance with the following:

$$Δ p = {\int }_{{z}_{lower}}^{{z}_{upper}} g δ ( z ) dz \qquad Eq . 2$$

wherein:
g is the gravitational acceleration, and
δ(z)=δ(T(z)) is the density of the liquid as a function of the temperature of the liquid.

Moreover, the method of the first aspect of the present disclosure may comprise determining a fluid flow rate of the liquid flowing in the at least one cooling duct on the basis of the liquid pressure difference Δp and a factor k indicative of the flow resistance of the duct.

As a non-limiting example, the fluid flow rate may be a volumetric flow rate Qv (for instance expressed in terms of volume per time unit such a m³/s) that can be determined in accordance with the following:

$${Q}_{ν} ∼ {( \frac{Δ p}{k} )}^{n} \qquad Eq . 3$$

wherein the exponent n is in the range of 0.5-1 (such that 0.5≤n≤1) and wherein the value of the exponent n depends on the implementation of the cooling duct 24. As a non-limiting example, the exponent n may equal 0.5 when the cooling duct 24 is a straight single duct and the exponent n may approach or even be equal to 1 for two parallel ducts.

As regards the heat loss value Q, indicative of a heat loss for the static electric induction device portion 20, the step of determining the heat loss value Q may comprise determining a value P indicative of an electric power fed to the static electric induction device portion 20. Purely by way of example, the value P indicative of an electric power fed to the static electric induction device portion 20 may be expressed as the electrical power (e.g. expressed in W or kW) actually fed to the electric power fed to the static electric induction device portion 20. As another non-limiting alternative, the value P indicative of an electric power fed to the static electric induction device portion 20 may be expressed as the electrical current component I (e.g. expressed in A) of the electric power actually fed to the electric power fed to the static electric induction device portion 20. The latter example may use the assumption that the voltage U is known, possibly even fixed.

FIG. 2 illustrates a profile of the heat loss value Q as a function of the vertical position z. Purely by way of example, the profile of the heat loss value Q may have been determined by determining a value P indicative of an electric power fed to the static electric induction device 14. As may be gleaned from FIG. 2, the heat loss value Q may be larger at the vertical uppermost and lowermost portions of the static electric induction device 14 than in a vertical centre portion of the static electric induction device 14.

Moreover, the profile of the heat loss value Q and the temperature profile in FIG. 2 indicate that a static electric induction device portion that is associated with an area of the static electric induction device with a relatively high temperature in comparison to its surroundings is often found in the vertical uppermost portion of the static electric induction device 14. This is since the vertical uppermost portion is associated with a relatively high heat loss value Q as well as a relatively high liquid temperature. As such, the relatively hot liquid at the vertical uppermost portion of the static electric induction device 14 may only cool the vertical uppermost portion of the static electric induction device 14 to a limited extent, whereby the vertical uppermost portion of the static electric induction device 14 can become relatively hot. As such, any hotspot of the static electric induction device 14 is generally found in the uppermost portion of the static electric induction device 14.

As a non-limiting example, the step of determining the temperature Tₚₒᵣₜ of the static electric induction device portion 20 using the liquid pressure difference Δp, the heat loss value Q and the liquid temperature value T_{liq}(zₚₒᵣₜ) may comprise determining a heat transfer coefficient h between the static electric induction device portion 14 and the liquid 16.

The heat transfer coefficient h is a function of the fluid flow rate Qv. Purely by way of example, a value of the heat transfer coefficient h may be determined using a look-up table using the current fluid flow rate Qv. As a non-limiting example, such a look-up table may be dependent on the material of the static electric induction device portion 20. The temperature Tₚₒᵣₜ of the static electric induction device portion 20 is determined as the sum of the liquid temperature value T_{liq}(zₚₒᵣₜ) and a parameter proportional to the ratio between the heat loss value Q and the heat transfer coefficient h.

As a non-limiting example, the temperature Tₚₒᵣₜ of the static electric induction device portion 20 may be determined in accordance with the following:

$${T}_{port} = {T}_{liq} ( {z}_{port} ) + \frac{Q}{hA} \qquad Eq . 4$$

wherein the factor A may be indicative of the cooling surface area of the static electric induction device portion 20.

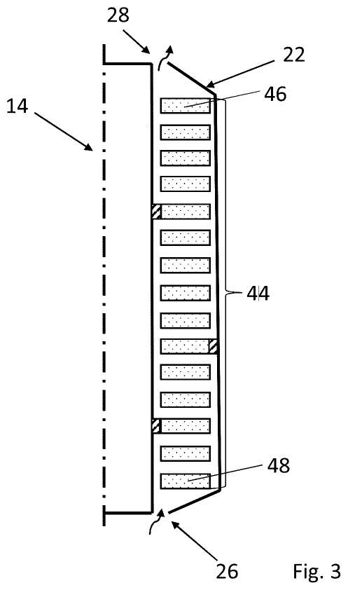

The static electric induction device 14 may be implemented in a plurality of different ways. With reference to FIG. 3, though purely by way of example, the static electric induction device may comprise a winding 44, wherein the static electric induction device portion is a portion of the winding.

In fact, in the FIG. 3 implementation of the static electric induction device 14, the winding 44 comprises a plurality of discs 46, 48. Moreover, as indicated in FIG. 3, the liquid may be adapted to flow from the lower inlet 26 and an upper outlet 28 and thus pass one or more sides of each one of the plurality of discs 46, 48. In the FIG. 3 implementation of the static electric induction device 14, the hotspot of the of the static electric induction device 14 may be associated with the uppermost disc 46. As such, in the FIG. 3 implementation, the static electric induction device portion 20 may form part of, or equal, the uppermost disc.

However, in other embodiments of the first aspect of the present disclosure, the method may comprise determining the temperature of each one of a set of discs of the plurality of discs 46, 48.

A second aspect of the present disclosure relates to a computer program product comprising program code for performing, when executed by a processor device, the method of the first aspect of the present disclosure.

A third aspect of the present disclosure relates to a non-transitory computer-readable storage medium comprising instructions, which when executed by a processor device, cause the processor device to perform the method of the first aspect of the present disclosure.

Moreover, it should be noted that a fourth aspect of the present disclosure relates to a control unit 50, see FIG. 1, arranged to perform the method of the first aspect of the present disclosure. To this end, though purely by way of example, the control unit 50 may be adapted to receive information from one or more portions of the static electric induction device assembly 10. As a non-limiting example, with reference to the FIG. 1 embodiment, the control unit 50 may be adapted to receive information from the temperature sensor assembly 30.

1. A method for determining temperature information, or information related to temperature information, related to a static electric induction device assembly, said static electric induction device assembly having a vertical extension in a vertical direction,
said static electric induction device assembly comprising an enclosure, a static electric induction device and a liquid, whereby said enclosure accommodates said static electric induction device and said liquid such that said static electric induction device is at least partially, preferably fully, submerged into said liquid, wherein said static electric induction device comprises a static electric induction device portion which is submerged into said liquid, said static electric induction device assembly further comprising an enclosing member,
said static electric induction device being at least partially enclosed by said enclosing member, wherein at least one cooling duct is formed between said static electric induction device and said enclosing member and/or wherein said at least one cooling duct extends at least partially through said static electric induction device, said at least one cooling duct being at least partially delimited by said static electric induction device portion, said at least one cooling duct comprising a lower inlet and an upper outlet, as seen in said vertical direction, wherein each one of said lower inlet and said upper outlet is in fluid communication with said liquid, said at least one cooling duct being adapted to convey said liquid from said lower inlet to said upper outlet, wherein said method comprises determining a liquid pressure difference between a liquid pressure at said upper outlet and a liquid pressure at said lower inlet, wherein said method comprises performing the following for at least said static electric induction device portion:
determining a heat loss value, indicative of a heat loss for said static electric induction device portion, said static electric induction device portion having a vertical static electric induction device portion position in said vertical direction;
determining a liquid temperature value, indicative of a temperature of the liquid in said vertical static electric induction device portion position, and
determining a temperature, or information related to temperature information, of said static electric induction device portion using said liquid pressure difference, said heat loss value and said liquid temperature value.

2. The method according to claim 1, wherein said method comprises determining a temperature profile indicative of a temperature of said liquid inside said enclosure but outside said enclosing member at a plurality of different vertical positions between an upper outlet vertical position of said upper outlet and a lower inlet vertical position of said lower inlet.

3. The method according to claim 2, wherein said step of determining said liquid temperature value comprises using said temperature profile and said vertical static electric induction device portion position in said vertical direction of said static electric induction device portion.

4. The method according to claim 2, wherein said feature of determining said temperature profile comprises using a plurality of temperature sensors arranged inside said enclosure but outside said enclosing member between said upper outlet vertical position and said lower inlet vertical position.

5. The method according to claim 2, wherein said feature of determining said temperature profile comprises the following:
determining measured temperature data using a measurement assembly, said measured temperature data comprising a temperature in each one of a plurality of different locations of said static electric induction device assembly as a function of time for a reference time range when the static electric induction device assembly is in a condition in which at least a portion of said static electric induction device generates heat during at least a portion of said reference time range,
generating a temperature model for estimated temperature data, said estimated temperature data corresponding to an estimated temperature in each one of said plurality of different locations of the static electric induction device assembly as a function of time, said temperature model comprising a learning model representing said estimated temperature data as well as said measured temperature data, and
training said learning model using said measured temperature data to thereby obtain said temperature model, and
determining said temperature profile using said temperature model.

6. The method according to claim 5, wherein said learning model comprises a neural network, preferably a multilayer neural network.

7. The method according to claim 5, wherein said measurement assembly comprises a fibre optic sensor that is located within said enclosing member, preferably said static electric induction device comprises a winding and said fibre optic sensor is at least partially located in said winding.

8. The method according to claim 2, wherein said step of determining said liquid pressure difference between said liquid pressure at said upper outlet and said liquid pressure at said lower inlet comprises using said temperature profile and information relating to a density of said liquid as a function of temperature.

9. The method according to claim 1, wherein said method comprises determining a fluid flow rate of said liquid flowing in said at least one cooling duct on the basis of said liquid pressure difference and a factor indicative of the flow resistance of said duct.

10. The method according to claim 1, wherein said step of determining said heat loss value comprises determining a value indicative of an electric power fed to said static electric induction device portion.

11. The method according to claim 9, wherein said step of determining said temperature of said static electric induction device portion using said liquid pressure difference, said heat loss value and said liquid temperature value comprises determining a heat transfer coefficient between said static electric induction device portion and said liquid, said heat transfer coefficient being a function of said fluid flow rate, wherein said temperature of said static electric induction device portion is determined as the sum of said liquid temperature value and a parameter proportional to the ratio between said heat loss value and said heat transfer coefficient.

12. The method according to claim 1, wherein said static electric induction device comprises a winding, wherein said static electric induction device portion is a portion of said winding, preferably said winding comprises a plurality of discs and said method comprises performing the method according to claim 1 for each one of a set of discs of said plurality of discs.

13. The method according to claim 1, wherein said static electric induction device portion is associated with an area of said static electric induction device with a relatively high temperature in comparison to its surroundings.

14. A computer program product comprising program code for performing, when executed by a processor device, the method of claim 1.

15. A control unit arranged to perform the method of claim 1.
